(19) United States
(12) Patent Application Publication
(10) Pub. No.: US 2023/0323045 A1
(43) Pub. Date: Oct. 12, 2023

(54) MELT-PROCESSABLE, IMPACT RESISTANT FIBER-REINFORCED COMPOSITE MATERIALS

(71) Applicant: 3M INNOVATIVE PROPERTIES COMPANY, St. Paul, MN (US)

(72) Inventors: Terry R. Hobbs, Stillwater, MN (US); Eumi Pyun, St. Paul, MN (US)

(21) Appl. No.: 18/021,044

(22) PCT Filed: Aug. 17, 2021
(86) PCT No.: PCT/IB2021/057571

§ 371 Date: Feb. 13, 2023

Related U.S. Application Data
(60) Provisional application No. 62/706,492, filed on Aug. 20, 2020.

(51) Int. Cl. C08J 5/04

(52) U.S. Cl. CPC C08J 5/046; C08J 2377/02; C08J 2377/10

(57) ABSTRACT

Fiber-reinforced composite materials include a matrix of a thermoplastic polyamide resin, at least 3 weight% of at least one impact modifier, and 7-60 wt% fiber reinforcing agent of discontinuous meta-aramid fibers. The composite material is melt processable, and is impact resistant as measured by an unnotched Izod test method according to ASTM D4812 having a value of at least 12 ft-lbs/in (640 J/m). The composite materials can be used to prepare articles such as safety articles.

### FIELD OF THE DISCLOSURE

The current disclosure relates to fiber reinforced composite materials that are melt-processable and display excellent impact properties and articles that are prepared from the composite materials.

### BACKGROUND

A wide variety of composite materials have been used to prepare a wide range of articles. A composite material (commonly shortened to “composite”) is a material made from two or more constituent materials with significantly different physical or chemical properties that, when combined, produce a material with characteristics different from the individual components. The individual components remain separate and distinct within the finished structure, differentiating composites from mixtures and solid solutions. The new material may be preferred for many reasons. Common examples include materials which are stronger, lighter, or stiffer when compared to traditional materials.

Examples of composites include reinforced concrete and masonry, composite wood materials such as plywood and fiberboard, reinforced plastics such as fiberglass reinforced nylons, ceramic matrix composites, and metal matrix composites.

### SUMMARY

The current disclosure relates to fiber reinforced composite materials that are melt-processable and display excellent impact properties and articles that are prepared from the composite materials.

In some embodiments, the composite materials comprise a matrix comprising at least one thermoplastic polyamide resin, at least one impact modifier comprising at least 3 weight% based on the total weight of the composite material, and 7-60 wt% fiber reinforcing agent based upon the total weight of the composite material. The fiber reinforcing agent comprises discontinuous meta-aramid fibers. The composite material is melt processable, and is impact resistant as measured by an unnotched Izod test method according to ASTM D4812 having a value of at least 12 ft-lbs/in (640 J/m).

Also disclosed are articles. In some embodiments, the article comprises a fiber-reinforced composite material, comprising a matrix comprising at least one thermoplastic polyamide resin, at least one impact modifier comprising at least 3 weight% based on the total weight of the composite material, and 7-60 wt% fiber reinforcing agent based upon the total weight of the composite material. The fiber reinforcing agent comprises discontinuous meta-aramid fibers. The composite material is melt processable, and is impact resistant as measured by an unnotched Izod test method according to ASTM D4812 having a value of at least 12 ft-lbs/in (640 J/m). In some embodiments, the article comprises a personal safety article. Among the personal safety articles comprise a helmet, a face shield, a mask, safety glasses, powered air respirators or components of powered air respirators, self-contained breathing apparatus, air filters, filter housings, protective earwear, protective boots or boot inserts.

### DETAILED DESCRIPTION

A wide variety of composite materials have been used to prepare a wide range of articles. A composite material (commonly shortened to “composite”) is a material made from two or more constituent materials with significantly different physical or chemical properties that, when combined, produce a material with characteristics different from the individual components. The individual components remain separate and distinct within the finished structure, differentiating composites from mixtures and solid solutions. The new material may be preferred for many reasons. Common examples include materials which are stronger, lighter, or stiffer when compared to traditional materials.

Many composites are formed by forming a grid of reinforcing material, surrounding this grid with a curable matrix material, and curing the matrix to form the composite. Examples include reinforced concrete where a grid of metal bars (rebar) is formed and then concrete is poured around the grid and allowed to harden. Another example is a FRP (fiber-reinforced polymer or fiber-reinforced plastic), where a fabric of reinforcing fibers or a fibrous web, referred to as a preform, is surrounded by a curable resin (such as a thermoset epoxy) and then the curable resin is cured to form the composite. Fiber reinforced composites are widely known and have been used industrially in various applications for over 40 years. Composites that utilize continuous fibers in the form of tows or as woven fabrics display excellent mechanical properties and are commonly known as continuous fiber composites.

While these types of composites are very useful, the need remains for composites that do not utilize continuous fibers, and where the entire composite material is melt processable. Such composites are referred to as discontinuous fiber composites and typically use synthetic fibers that are less than 25 mm in length. Discontinuous fiber composites can be formed into a wide variety of shapes, including highly curved shapes by common plastic processing techniques such as thermoset injection molding or thermoplastic injection molding. Discontinuous fiber composites are well known in the art and widely used in a variety of applications. These include polyamide (nylon) thermoplastic resins that are reinforced with synthetic glass, ceramic, carbon, graphite, or aramid fibers. While it is known that discontinuous glass reinforced and carbon fiber reinforced nylons have very good mechanical properties, the discontinuous aramid reinforced thermoplastic nylons have relatively poor mechanical properties such as tensile strength and impact strength. This is in direct contrast to continuous aramid fiber composites and aramid woven fabrics that display excellent impact properties. In fact, continuous aramid composites made with thermosetting epoxies are known to even have ballistic properties against small caliber firearms. Because these composites are both lightweight and impact resistant, they are used in a variety of aircraft and marine applications and often include glass or carbon fibers to form continuous hybrid composites. On the other hand, discontinuous aramid reinforced thermoplastics are well known to have properties that are the opposite of continuous aramid fiber composites, having poor impact resistance and are exceptionally notch sensitive.

Impact resistance is often a very important engineering design requirement and product feature that is used in the selection of materials during engineering design. Impact resistance can be measured by a variety of techniques depending on the end use application. One test method that is used frequently by material manufacturers for both plastics and composites is called the unnotched Izod impact test (according to ASTM D4812). In this test, a bar, one end which is held in a vice vertically, is struck by a striking device under controlled conditions. The energy required to break the test bar is noted. This test method is routinely used to compare two or more different materials under a specified environmental condition.

Despite the poor impact resistance properties of discontinuous aramid composites, considerable effort has been directed to these composite materials as they have other desirable properties. Discontinuous aramid composites, known in the art such as short aramid fiber reinforced nylons, have one advantage compared to their glass-reinforced counterparts: exceptional abrasion resistance. As a result, they are used commercially for specialty applications such as sliding parts, gears, sprockets, pinions and the like. It is well known that these composite materials have excellent abrasion resistance despite the poor impact properties, where the impact strength as measured by unnotched Izod (ASTM D4812) is typically 9-10 ft-lbs/in. Such discontinuous aramid fiber composite materials are available from a variety of plastic compounders including RTP company, Celanese Inc., and DuPont, Inc. Long fiber aramid nylon composites are also known in the art and are sold commercially by Celanese. Despite the longer fiber length (12 mm), these materials with 35 wt% aramid fiber still have low impact strength (10 ft-lbs/in.). In comparison, commercially available long glass fiber composites with 35 wt% fiber have excellent impact strength (16-20 ft-lbs/in). Because of their excellent combination of impact resistance, stiffness, strength and chemical resistance, glass reinforced nylons have been one of the most widely used engineered materials over the last 45 years.

Presented herein are a new class of discontinuous aramid fiber composites that have a variety of desirable and unexpected properties including excellent impact properties and hot melt processability. These composites have unnotched Izod impact values that can exceed 33 ft-lbs/in., making them exceptionally useful as an engineering thermoplastic material for a variety of industrial, medical, and safety applications. Because of the exceptional impact properties, the composite materials of this disclosure are particularly useful for replacing conventional engineering thermoplastic materials such as nylons, glass reinforced nylons, polycarbonates, acetals, and polyesters. Disclosed herein are such types of composites that contain a nylon matrix, an impact modifier, and discontinuous meta-aramid fibers. The discontinuity of the fibers means that the fibers are dispersed into the matrix and have a discrete length. Discontinuous fiber composites can further be classified as short fiber composites (with a fiber length of 1 mm or less) or long fiber composites (where the average fiber length is 1-50 mm, typically around 12 mm prior to molding). It should be understood that discontinuous fiber composites usually have a distribution of fiber lengths that is dependent upon the initial starting fiber length and molding conditions during manufacture.

Meta-aramid fibers are less well known than para-aramid fibers, such as KEVLAR or poly(p-phenylene terephthalamide), and have properties different from para-aramids. Commercial meta-aramid fibers are based on the polymer, poly(m-phenylene isophthalamide). The difference in properties between meta-aramid and para-aramid fibers is a direct result of the different sites of substitution sites on the phenylene rings of the polymer backbone. Meta-aramid polymers have inherent kinking of the polymer backbone due to the fact that the substituted sites are at the 1,3 positions on the phenylene ring with meta aramid based polymers, as opposed to the more linear para-aramid polymers where the substituted sites are at the 1,4 positions on the phenylene ring. It is well known that meta-aramid fibers are significantly weaker compared to their para aramid counterparts and have lower crystallinity, a lower glass transition temperature, and lower thermal stability. In addition, they have lower molecular orientation, and tensile moduli. However, despite the meta-aramid fibers being at least four times weaker than para-aramid fibers, they are still relatively strong with a tensile strength similar to common steel alloys (600-800 MPa). In addition, unlike the para-aramid fibers, the meta-aramid fibers are quite ductile and have elongation to break values in excess of 20% compared to 3-4% elongation for para-aramid fibers. While not wishing to be bound by theory, it is believed that one of the benefits of using discontinuous meta-aramid fibers is that they are relatively flexible during melt processing and are better able to retain their fiber length (i.e. not break down during processing) due to their lower stiffness and higher ductility. It is also believed that the composites of this disclosure are exceptionally tough because of the combination of better fiber adhesion of meta-aramid fibers to the specified nylon matrix polymer, higher ductility of meta aramid fibers, and lower stiffness of the fiber. All of these characteristics improve flexibility and impact resistance, allowing an impact load to be more evenly and widely distributed in the composite material. The composites of this disclosure also act as ductile materials and can resist the application of large strains (>15%) without failing in a brittle manner. This provides another mechanism of increased energy absorption compared to traditional composite materials (such as glass fiber composites and para-aramid fiber composites) that fail at lower strains.

In some embodiments, the composites of this disclosure further include an interfacial modifier. It is believed that the interfacial adhesion between the meta-aramid fiber and the matrix nylon can be improved or optimized by addition of interfacial modifiers in the composites. In some embodiments, the composites of this disclosure have exceptionally high impact strength through the use of interfacial modifiers in conjunction with discontinuous aramid fibers. Without being bound by theory, it is believed that certain interfacial modifiers can covalently bond to both the fiber surface and to the nylon resin. Modifiers can also alter the surface energy of the reinforcing fiber and/or enhance hydrogen bonding forces. These modifiers can possibly enhance like-like or polar interactions at the fiber surface or even create chain entanglement at the fiber surface.

The composites of this disclosure have exceptional impact properties and are far superior compared to discontinuous aramid fiber thermoplastic composites known in the art. In some embodiments, the composites have such high impact strength (for example, unnotched Izod values > 34 ft-lbs/in), that they are even superior to most commercially available short glass fiber reinforced nylons and short carbon fiber reinforced nylons. As a result, the composites of this disclosure are exceptionally useful as replacements for these traditional short fiber composites including glass reinforced nylons and glass reinforced polyesters. Replacement of glass reinforcing fibers is desirable because the glass fibers can be abrasive and have a higher density. In contrast, the composites of this disclosure with meta-aramid discontinuous fibers are non-abrasive and have a lower density. As a result, during manufacturing operations such as injection molding, the tool life of the molds and screws with the composite materials of this disclosure can be 10-20 times longer compared to glass filled materials. This can have a significant impact on the cost per part over several years.

Additionally, the composites of this disclosure have very low density. This results from the use of meta-aramid fibers that are lower in density compared to glass fibers (1.37 g/cc vs. 2.70 g/cc). Because of the low density and high impact strength, the composites disclosed herein are exceptionally useful for light weight applications including automotive parts, aircraft parts, and components of safety products including but not limited to respirators, helmets, fire safety products, goggles, and welding shields.

As mentioned previously, continuous fiber-reinforced composites have long, generally continuous fibers that run the length of a fabricated part, providing strength and impact resistance. The use of discontinuous fibers is not expected to give the exceptional strength properties that have been obtained with continuous fibers such as tensile strength or flexural strength. However, it has been discovered that the current composite materials using discontinuous meta-aramid fibers have unexpectedly large property improvements in impact resistance and ductility, and they also have a lower density.

Composites with discontinuous fibers can be prepared by mixing the discontinuous fibers with a thermoplastic matrix material. Composite materials can be compounded and prepared by various methods that involve high or low shear mixing such as twin screw or single screw extruders. Additional discontinuous fibers can be included in the composites such as glass fibers, metal fibers, carbon fibers, and para-aramid fibers. Some fibers, especially the relatively hard glass fibers, can be abrasive to processing equipment and molds and this can be undesirable, as described previously.

One need for strong and flexible composite materials is in the use of personal safety articles. Examples include helmets, face shields, protective eyewear, reusable respirators and the like. These articles come in a wide range of shapes and desirably are lightweight. Impact resistance is particularly important for such articles. Impact resistance is a measure of the resistance of materials to mechanical impact without undergoing any physical changes. Impact resistance can be measured in a variety of ways. As described previously, one test that has been found to be particularly useful in measuring impact resistance is the unnotched Izod test method according to ASTM D4812, as described in the Examples section. This test is widely used in the plastics industry and allows two or more materials to be directly compared to one another.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “thermoplastic” is used consistent with the commonly understood definition in the polymer art and refers to a plastic polymer material that becomes pliable or moldable at a certain elevated temperature and solidifies upon cooling. Unlike a thermoset material in which the solidification is permanent, in a thermoplastic material, the cycle of heating to become pliable and solidification upon cooling can be repeated numerous times.

The term “polyamide” as used herein refers to polymers with polyamide linkages. Polyamide herein is often used interchangeably with the word “nylon”. Amide linkages are of the type: —(—R_{b}—(CO)—NRₐ—R_{c}—)—, where R_{b} is an alkylene or arylene group, Rₐ is hydrogen or an alkyl group, R_{c} is alkylene or arylene group, and (CO) is a carbonyl group —C═O. Polyamides (also often referred to a nylons) are made from either the condensation of diamines and dibasic acids or the condensation of amino acids containing both amine and acid functional groups in single molecules. The term “aramid” as used herein refers to polyamides containing at least 85% aryl groups linked by amide linkages.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning Calorimetry (DSC) at a scan rate of 10° C./minute, unless otherwise indicated. Typically, Tg values for copolymers are not measured but are calculated using the well-known Fox Equation, using the homopolymer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “heteroalkylene” refers to a divalent group that includes at least two alkylene groups connected by a thio, oxy, or -NR- where R is alkyl. The heteroalkylene can be linear, branched, cyclic, substituted with alkyl groups, or combinations thereof. Some heteroalkylenes are poloxyyalkylenes where the heteroatom is oxygen such as for example, —CH₂CH₂(OCH₂CH₂)ₙOCH₂CH₂—.

Disclosed herein are composite materials. In some embodiments, the composite material comprises a matrix comprising at least one thermoplastic polyamide resin, at least one impact modifier comprising at least 3 weight %, such as 3-35 weight%, based on the total weight of the composite material, and a discontinuous fiber reinforcing agent. The fiber reinforcing agent comprises discontinuous meta-aramid fibers where the composite material is melt processable, and is impact resistant as measured by an unnotched Izod test method according to ASTM D4812 having a value of at least 12 ft-lbs/in (640 J/m).

The composite material comprises a matrix that comprises at least one thermoplastic polyamide resin. A wide range of polyamide resins are suitable. It is believed that the matrix being a polyamide resin promotes compatibility with the meta-aramid fiber reinforcing agent. Without being bound by theory, it is believed that the polyamide resin may hydrogen bond with the surface of the aramid fiber thereby promoting adhesion. Additionally, it is believed that a high concentration of aromatic groups in the matrix nylon improves the miscibility at the fiber surface. In some embodiments, the thermoplastic polyamide resin is an aliphatic polyamide or a semi-aromatic polyamide. The thermoplastic polyamide may be a homopolymer or a copolymer. Mixtures and blends of thermoplastic polyamides may also be used.

Suitable polyamide materials can be described by the repeat unit of general formula 1:

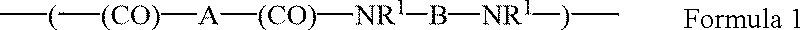

where A and B are independently alkylene, heteroalkylene, aralkylene, or arylene groups; (CO) is a carbonyl group -C=O; and R¹ is hydrogen atom or an alkyl group. If at least one of A or B is an aralkylene or arylene group, the polyamide is described as semi-aromatic. Generally, the groups A and B comprise 1-20 carbon atoms and may contain one or more heteroatoms, generally oxygen, nitrogen or sulfur. In some embodiments, the groups A and B comprise 1-15 carbon atoms or even 1-10 carbon atoms. In some embodiments, the polyamide is a A-B type copolymer such as poly (hexylene adipate), also known as nylon 6,6.

Frequently, polyamide polymers are prepared from the condensation reaction of a diacid (or equivalent such as an acyl halide) with a diamine as shown in Reaction Scheme 1:

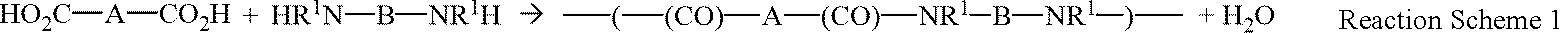

where A and B and R¹ are as described above.

A wide range of thermoplastic polyamide resins are suitable. These include commercially available nylons such as nylon 6, nylon 6,6, nylon 6,12, nylon 6,10, nylon 9T, nylon 6I also known as poly (hexamethylene isophthalamide), PPA, and high temperature nylon (HTN) resins utilizing terephthalic acid or other aromatic acids as a building block. In addition, nylon blends that constitute a polyamide or copolyamide as the major polymer component may be used. These blends may utilize polyesters, polypropylenes, or siloxane copolymers as a minor component.

The composite material comprises an impact modifier, which is an additive that improves the impact resistance of the base nylon polymers. It is noteworthy that nylons by themselves are known as tough materials. The amount of impact modifier used in a particular composition is often dependent on the intended end-use application for that composition. Impact modifiers can be soft or rigid materials, but generally compromise a material that is elastomeric and forms a phase-separated, discrete domain in the nylon matrix that is usually about 0.2-3.0 micrometers in diameter. This morphology uses the known mechanisms of increased shear yielding, crazing, and possibly cavitation in the host polymer to significantly enhance the ability of the host polymer to absorb energy. This can be accomplished by using a variety of polymeric additive materials as impact modifiers including, but not limited to, maleated olefin elastomers, core shell particles, grafted block copolymers, epoxy modified polymers, elastomeric copolymers, ethylene terpolymers, ionomer, and modified butadiene copolymers including core shell particles. The use of impact modifiers for nylon resins is known in the art. Among the particularly suitable impact modifiers are core shell particles and maleated elastomers. Commercially available examples of impact modifiers include PARALOID EXL 2335 and EXL 2314 from Dow chemical (MBS core shell modifier) and ROYALTUF 485 and ROYALTUF 527 available from Addivant. In the composite compositions of this disclosure, one or more impact modifiers may be used to enhance the impact resistance of the composite material. It is believed that in some compositions with aliphatic nylons, the impact modifiers may play a secondary role by improving the adhesion to the fibers. Core shell particles are particularly useful impact modifiers because they do not require high shear mixing to achieve the desired morphology and particle size. Generally, impact modifiers are used at a level of at least 3 wt% up to as much as 35 wt%, more typically 8-25 wt% based on the total weight of the composite material. Besides improving impact performance, impact modifiers can also improve the ductility of the composite at lower temperatures by altering the ductile/brittle transition. An overall role of the impact modifier in the composites of this disclosure is to alter the nylon matrix and encourage yielding. This is particularly evident in the composites described below, because they are exceptionally ductile even at strains exceeding 20% in a complex stress state. As a result, when formulated to an optimal level, the compositions described herein are exceptionally tough and practically unbreakable especially after molded parts are allowed to reach near equilibrium moisture content.

The composite material also comprises a fiber reinforcing agent that are discontinuous meta-aramid fibers. Meta-aramid fibers are aromatic polyamides that have the amide linkages on the 1, 3 positions on the aromatic rings. The general structure of a well known meta aramid, also known as poly(m-phenylene isophthalamide), is shown in general formula 2. Meta-aramid fibers with this polymer structure are commercially available for example as NOMEX from Dupont and TEIJINCONEX from Teijin. Herein, meta-aramid fiber is defined as a polyamide fiber where at least 85% of the amide are attached to aromatic groups in the polymer backbone, with at least 25% of the amide groups comprising aromatic meta linkages. As described above, poly(m-phenylene isophthalamide) is a well known meta-aramid fiber containing all meta linkages. Fibers prepared from aromatic copolyamides containing both meta-aramid and para-aramid linkages may be useful according to this disclosure as long as they contain enough meta linkages to meet the above stated definition of meta-aramid fiber. Commercially available meta-aramid fibers suitable for the composites of this disclosure include NOMEX fibers from Dupont, TEIJINCONEX from Teijin Aramid, part of Teijin Ltd., and ARAWIN fibers by Toray Advanced Materials Korea Inc. Fibers useful in this disclosure typically have a diameter of 10-25 micrometers and may be non-circular or elliptical in their cross-sectional shape. It is desirable that the fibers are wholly intact and not fibrillated. While fibrillation may increase surface area, this morphological feature is not desired and can increase the viscosity of the thermoplastic composite in the melt during processing. The use of fibrillated aramid fibers is taught, for example, in EP Patent Publication No. 3,401,355.

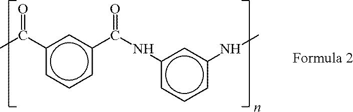

The fibers in the composites of this disclosure are discontinuous, meaning that the fibers are discrete fibers of a defined length. The fibers are generally 50 millimeters or less in length. However, for certain processes such as compression molding, longer fibers such 50-62 mm in length may be used. There are two general categories of fibers that are suitable for use in the melt processable composites of this disclosure. The first general category are “long” fibers that are of a length greater 1 mm, generally having a length of 1-50 millimeters, or even 1-20 millimeters. The second general category are “short” fibers that are less than 1 millimeter in length.

The fiber reinforcing agent comprises at least meta-aramid fibers and may also comprise other fibers. In some embodiments, the fiber reinforcing agent further comprises carbon fibers. Carbon fibers are generally present as a minor component of the fiber reinforcing agent, meaning that the carbon fibers are present as less than 50% by weight of the total weight of fiber reinforcing agent. However, for structural parts, it may be useful for the carbon fiber to be at a higher level such as 60-75% by weight of the total weight of fiber reinforcing agent. In some embodiments, the composites of this disclosure are hybrid composites of meta-aramid fibers and carbon fibers that have both excellent impact properties and low density. Compared to meta-aramid fiber reinforcement alone, these hybrid materials using both meta-aramid and carbon fibers have an increased number of beneficial properties including: higher heat deflection temperature (HDT); higher stiffness; and higher flexural and compressive strength. Such composite materials have an overall excellent balance of mechanical properties and still maintain excellent impact resistance, with unnotched Izod impact values exceeding 25 ft-lbs/in. Furthermore, the mechanical properties and density can be “tuned” for a given application by adjusting the percentages of the meta-aramid fibers and carbon fiber in the composition. Because hybrid composites with carbon fibers exhibit an overall balance of desirable properties such as solvent resistance, low density, high impact resistance, high strength, high stiffness, excellent abrasion resistance, and high temperature resistance (>100° C.), they can be used commercially in a large number of applications including moving and stationary parts. Examples include machine parts, levers, tools, screws, gears, conveyer parts, textile machinery parts, agricultural and processing equipment, chemical and fluid pumps, automotive components parts, aerospace parts, engine components, cooling system parts, off road vehicles, sporting good applications, bolts, threaded assemblies, household and commercial appliances, precision machined parts, and marine applications. These materials also are exceptionally useful for a wide range of safety and engineering applications. One nonlimiting example is the replacement of aluminum and cast magnesium alloys as an engineering material for light weight parts. These hybrid fiber reinforced nylon composites are also exceptionally useful for replacing traditional glass reinforced nylons, which are used in large volumes for producing molded goods across many industries. In some embodiments, the hybrid composites may utilize fibers of different fiber lengths. For example, one could use the combination of short carbon fibers along with long meta-aramid fibers or use a different combination such as short carbon fibers with short aramid fibers. The later may be useful for injection molding very thin wall parts or very fine features in a molded part. In another embodiment, the hybrid composites may further comprise a flame retardant as described below. Such composites are useful for electrical, electronic, and fire-safe applications.

In some embodiments, the fiber reinforcing agent can contain in addition to the meta-aramid fibers, synthetic fibers other than carbon fibers. These fibers include e-glass fibers, s-glass fibers, a-glass fibers, graphite fibers, boron fibers, metal fibers, other aramid fibers, stainless steel fibers, and ceramic fibers. Combinations of meta-aramid fibers and glass fibers are particularly suitable because they are lower in cost and easy to process and have a balance of properties.

A wide range of fiber loadings are suitable in the composites of this disclosure. In some embodiments, the fiber reinforcing agent is present at a loading of 7-60 wt% based on the total weight of the composite composition, in some embodiments 10-50 wt%.

Besides the thermoplastic polyamide resin, impact modifier, and fiber reinforcing agent described above, the composites may further comprise other additional optional additives. The optional additives can enhance the desirable properties described above or can provide additional desirable properties. Examples of suitable optional additives include flame retardants, interfacial modifiers, or combinations thereof.

In some embodiments, at least one flame retardant is added to the composite. A wide range of flame retardants are suitable including halogenated and non-halogenated flame retardants. A particularly suitable class of flame retardant additives are phosphorus containing flame retardants including metal phosphinates and red phosphorus. Another useful class is brominated polymeric flame retardants. Red Phosphorus is a particularly desirable flame retardant because it is effective in nylon composite compositions at relatively low levels. In particular, red phosphorus can be an effective flame retardant in nylon composites at levels of about 7 wt%. Because less than 10 wt% can be used, red phosphorus is not expected to significantly adversely affect the impact performance. Other flame retardants require higher levels to be effective, typically 20-25 wt%, and it is anticipated that these higher levels may adversely affect the impact performance or other desirable properties of the composite.

A wide range of interfacial modifiers are suitable for inclusion in the composites of this disclosure. Interfacial modifiers can play a variety of roles in these composites. These roles include increasing and/or optimizing fiber to matrix adhesion, decreasing melt viscosity, reducing molded in stresses, reducing interfacial tension and melt viscosity, and improving stress transfer to the fiber and/or impact modification phase. Many of these roles serve to improve impact performance. Some interfacial modifiers may also function as compatibilizers for the fiber reinforcing agents with the thermoplastic polyamide matrix. A wide range of interfacial modifiers may be suitable including low molecular weight functional organic compounds, copolymers, and polymers containing reactive groups. Examples of suitable interfacial modifiers include maleated polyolefin copolymers, long chain alcohols, long chain fatty acids, epoxy polymers and oligomeric resins, semi-aromatic nylon copolymers, block copolymers, zirconates, titanates, organosiloxane agents, and combinations thereof. The later three are especially useful for modifying surfaces of synthetic reinforcing fibers. Semi-aromatic nylon copolymers and polymers can be useful because they may contain segments that have a similar solubility parameter to the meta-aramid fiber and improve adhesion through hydrogen bonding and polar interactions. In addition, under high temperatures, they can entangle and undergo amide interchange reactions with the bulk nylon matrix. Hence, they interact and improve adhesion between the fiber and matrix. Maleated polymers such as maleated polyolefins, maleated olefin copolymers, and epoxy functional polymers are particularly useful because they can chemically react with the nylon matrix and/or the fiber reinforcing agent. This serves to both covalently graft polymer chains to a specified material phase and provide a means of creating or improving chemical compatibility. This surface modification at the fiber interface includes the creation of polar functional groups (including amide linkages), which can enhance interfacial adhesion through hydrogen bonding and/or other polar forces (i.e. dipole interactions) and improve adhesion via polymer grafting. The polymer chains attached covalently to one material phase such as the fiber surface are free to entangle, interact, and/or crystallize with polymer chains in the nylon matrix phase or impact modifier phases.

Other suitable additives and modifiers useful for composites of this disclosure include fillers, lubricants, processing aids, moisture scavengers, chain extenders, heat stabilizers, UV absorbers and stabilizers, corrosion inhibitors, antioxidants, metal salts, colorants, nucleating agents, carbon black, glass bubbles, ceramic powders, fluoropolymers, and plasticizers. It is important to note that some materials can be multifunctional, i.e. serve more than one function. For example, long chain alcohols and long chain acids can act as both a lubricant and as an interfacial modifier.

The composites of this disclosure can be prepared by a variety of techniques. Generally, the materials are prepared in a two-step process. In the first step, thermoplastic pellets are prepared. In the second step, the thermoplastic pellets are dried and then used to produce an article by processes known in the art, such as injection molding, rotational molding, or compression molding.

Thermoplastic pellets can be prepared by a variety of techniques using either low or high shear processes. One particularly suitable method of preparing short fiber meta-aramid composites uses conventional plastic compounding with a twin screw extruder. In this process, the thermoplastic polyamide resin and impact modifier along with optional interfacial modifier are mixed first in the beginning of the barrel, and the fiber reinforcement is introduced in the later part of the process at the end of the machine barrel to minimize fiber breakage and prevent fibrillation of the fibers. The molten material is then cooled and passed through a pelletizing operation where pellets of a discrete length are formed. These pellets can then be stored, shipped, or set aside for later use. The pellets can be used to form a variety of articles via a second step as described below.

The composites can also be prepared according to a one stage process: hot melt mixing of the thermoplastic polyamide resin, impact modifier, fiber reinforcing agent and optional additives followed by direct injection of the melt into a hot mold. A variety of hot melt mixing techniques using a variety of hot melt mixing equipment are suitable. Both batch and continuous mixing equipment may be used. Examples of batch methods include those using a BRABENDER (e. g. a BRABENDER PREP CENTER, commercially available from C.W. Brabender Instruments, Inc.; South Hackensack, NJ) or BANBURY internal mixing and roll milling equipment (e.g. equipment available from Farrel Co.; Ansonia, CN). Examples of continuous methods include single screw extruding, twin screw extruding, disk extruding, reciprocating single screw extruding, and pin barrel single screw extruding. Continuous methods can utilize distributive elements, pin mixing elements, static mixing elements, and dispersive elements such as MADDOCK mixing elements and SAXTON mixing elements.

In some embodiments, the compositions of this disclosure are prepared in pellet form using the two step process. Pellets can be prepared using known techniques to the plastics compounding industry including formulation using chopped fibers and other components using a twin screw extruder to create short fiber composites as described above. Alternatively, in other embodiments, long fiber pellets can be manufactured using a fiber pultrusion process which is used commercially to manufacture long carbon fiber and long glass fiber pellets. In this process, a tow of fibers is pulled through a hot polymer melt under pressure using specialized equipment and the resultant fully impregnated fiber bundle is chopped to a specified length to form a cylindrical pellet. Therefore, the fiber length is the same length as the pellet. Using this process, long fiber pellets comprising meta-aramid fibers with custom fiber lengths of 3-60 mm can be manufactured. The pultrusion process is a highly desirable process for making pellets of this disclosure, because the fibers themselves are not damaged and only low shear forces are used during the process for a short amount of time, often less than 25 seconds. The pellets can then be subsequently processed in a second step by a variety of known techniques to manufacture articles and molded goods. Suitable melt processing techniques for processing long fiber pellets include injection molding and compression molding.

Injection molding is a very useful technique for producing mold goods from the composite material pellets of this disclosure. Injection molding is probably the most widely used technique in the world to produce plastic molded goods and parts. Composites of this disclosure can be processed in a similar manner to glass reinforced nylons used commercially. Prior to molding, resin pellets are typically dried to a moisture content of 0.14 wt% or less. Generally, the composites of this disclosure are molded using moderate to fast injection speeds and higher mold temperatures (60-150° C.) with adequate holding pressure and time to minimize voids in the molded parts. The compositions of this disclosure are also useful for overmolding or insert molding in conjunction with plastics, other polymer composites, foams, metals, and elastomers.

Other methods of melt processing may be used to make molded parts with the composite pellets of this disclosure including compression molding, rotational molding, overmolding, extrusion, and 3D printing. The compositions of this disclosure can also be made into filaments by melt processing.

Because the composites of this disclosure are ductile at room temperature, articles can also be created using forming processes. The term “forming” is used to mean reshaping a nylon composite preform under pressure. For example, nylon 6,6-based composites of this disclosure can be reshaped in a simple forming process at a temperature of 180-200° C. and a pressure of 16,000-20,000 psi. Forming can result in a degree of strength and toughness unattainable by melt processes.

Also disclosed are articles prepared from the composites described above. In some embodiments, the article comprises a fiber-reinforced composite material comprising a matrix comprising at least one thermoplastic polyamide resin, at least one impact modifier comprising at least 3 weight% based on the total weight of the composite material, and a fiber reinforcing agent comprising at least 7 wt % based on the total weight of the composite material. The fiber reinforcing agent comprises discontinuous meta-aramid fibers. The composite material is melt processable, and is impact resistant as measured by an unnotched Izod test method according to ASTM D4812 having a value of at least 12 ftlbs/in (640 J/m).

The matrix, impact modifier, and fiber reinforcing agents are described in detail above. In some embodiments, the matrix comprises an aliphatic polyamide or a semi-aromatic polyamide. Impact modifiers can be soft or rigid materials, but generally compromise a material that is rubbery and forms a phase separated, discrete domain that is approximately 0.2-3.0 micrometers in diameter. These domains may vary in size and shape within a composite specimen. The fiber reinforcing agent comprises meta-aramid fibers with a length of 1-50 millimeter, more typically 1-20 millimeters (long fibers), meta-aramid fibers with a length of less than 1 millimeter (short fibers), a mixture thereof, and may also comprise other fibers such as carbon fibers, glass fibers, or other synthetic fibers as described above. In addition, in some embodiments, the composite further comprises at least one additive comprising a flame retardant, an interfacial modifier selected from maleated polyolefin copolymers, long chain alcohols, long chain fatty acids, epoxy polymers and oligomeric resins, semi-aromatic nylon copolymers, block copolymers, zirconates, titanates, organosiloxane agents, or combinations thereof. In some embodiments, the fiber reinforcing agent is present at a loading of 7-60 wt% based on the total weight of the composite composition, in some embodiments 10-50 wt%.

The composite materials can be used to prepare a wide range of articles. In some embodiments, the article comprises a personal safety article selected from a head protection article, a face protection article, eyewear protection, or a combination thereof. Examples of suitable personal safety articles include a helmet, a face shield or welding article, a mask, safety glasses, powered air respirators or components of powered air respirators, self-contained breathing apparatus, air filters, filter housings, protective earwear, protective boots or boot inserts. Suitable components may include turbo housings, fan blades, battery housings, battery packs, buckles, clips, valve bodies, air regulator parts, tubes, threaded connectors, valves, blower parts, housings, and the like.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: mm = millimeters; m = meters; ft = feet; in = inch; RPM = revolutions per minute; psi = pounds per square inch; lb = pounds; J = Joules; min = minutes; hrs = hours; RH = Relative Humidity. The terms “weight %”, “% by weight”, and “wt%” are used interchangeably.

Table of Abbreviations

| | |
|---|---|
| Abbreviation or Trade Designation | Description |
| Nylon-1 | ULTRAMID A3Z UV HP, is an impact modified nylon 6,6 containing UV stabilizers, commercially available from BASF. |
| Nylon-2 | GENESTAR 9T, grade N1006A, a toughened grade with no fiber content, commercially available from Kuraray, Inc. This material is known to contain a rubber modified phase as an impact modifier. |
| MA Fibers | Meta-aramid fibers prepared by cutting a cross-ply web fabric commercially available from Tencate, into 7-10 mm lengths with an average fiber diameter of 12-16 micrometers. |
| Carbon Fibers | Carbon fibers T700 with 0.9% epoxy sizing commercially available from Toray America. |
| Interfacial-1 | Interfacial Modifier-1, maleated polypropylene commercially available from Eastman as G-3003. |
| Interfacial-2 | Interfacial Modifier-2, behenyl alcohol powder commercially available from Sigma Aldrich. |
| FR-1 | Flame Retardant-1, organic phosphinate commercially available from Clariant as EXOLIT OP 1230. |
| FR-2 | Flame Retardant-2, organic phosphinate commercially available from Clariant as EXOLIT OP 945. |
| Impact Modifier-1 | Impact Modifier-1, maleated polyolefin copolymer commercially available from SI GROUP as ROYALTUF 485. |

### Test Methods

### Unnotched Izod Impact Testing

Test bars were prepared as described below and Unnotched Izod testing was completed according to ASTM D4812. The test values were measured in J/m (Joules per meter) and converted to the more conventionally used value of foot-pounds per inch (ft-lbs/in). The average of 2 test bars are reported using both sets of units.

### Flammability Test

Test bars were prepared as described below and tested for flammability according to Underwriter’s laboratory (UL) test.

### Ductility Test

Test bars were prepared as described below and tested for ductility by flexing a test bar to a 20° angle beyond the yield point of the composite. If the test bar was able to be so flexed beyond a 30° angle and had permanent deformation indicating that the composite test bar was ductile (>10% strain), the result was listed as “YES”.

### EXAMPLES

### Preparation of Molded Materials

All examples were prepared by mixing the precut fibers (fiber length 7-10 mm.) into a polymer melt using a conical batch twin screw mixing unit at 100 rpm with a total mixing time of 3-4 minutes. Composite resins were prepared by adding the polymer and additives slowly into the mixing chamber with a mixing time of 2 minutes to create a uniform melt phase. After 2 minutes of mixing, the discontinuous fibers were added over a short time frame and mixed with the polymer melt under high shear for 55-70 seconds. For the sample containing carbon fibers, the carbon fiber was introduced to the melt first followed by the meta-aramid fibers. The polymer melt temperature was 318° C. for all Nylon-2 (nylon 9T) samples and 300° C. for all impact modified Nylon-1 (nylon 6,6) samples. After high shear mixing, the polymer melt was injected into a heated mold under a pressure of 280 psi for a dwell time of 20 seconds to produce a composite test bar (127 mm × 12.5 mm × 3.2 mm). The mold temperature was 130° C. for the Nylon-2 (nylon 9T) samples and 102° C. for all Nylon-1 (nylon 6,6) samples. The samples were then removed from the mold and allowed to condition at room temperature and 50% RH for 2 weeks prior to testing unless noted otherwise.

### Example 1 and Comparative Examples C1-C3

Sample test bars were prepared using Nylon-1 with 23 wt% MA Fibers and 2 wt% Interfacial-1 using the method described above. Comparative sample results using the same test method for commercially available fiber reinforced materials are shown in Table 1. Unnotched Izod testing was made for the sample test bars and are reported in Table 1. This data is for specimens aged for 2 weeks at room temperature and 50% humidity.

TABLE 1

| Example | Material Description | Supplier | Unnotched Izod ft-lbs/in (J/m) |
|---|---|---|---|
| E-1 | 23% MA fibers and 2% Interfacial-1 | ---- | 24.9 (1,330) |
| C-1 | 20% aramid in nylon 6,6 | RTP Company | 10.0 (534) |
| C-2 | 20% glass fiber in IM nylon 6,6 | RTP Company | 19.0 (1,010) |
| C-3 | 30% glass fiber in IM nylon 6,6 | RTP Company | 21.0 (1,120) |

### Example 2

Two individual test bars were molded individually as described above with the following composition: Nylon-2 (56 wt%); MA fibers (22 wt%); FR-1 (22 wt%). 2 bars were tested for flammability according to flammability test given above. Both samples had a result of V-0. One test bar was flexed to a 30° angle beyond the yield point of the composite indicating that the composite test bar was ductile (>10% strain) and had permanent deformation. The test bar showed significantly greater stiffness compared to a test bar without the meta-aramid fiber.

### Example 3

Test bars with 2 different levels of FR-2 were prepare as described above. The Flammability and bend test data are shown below in Table 2.

TABLE 2

| Example | Nylon-2 (wt%) | MA fiber (wt%) | FR-2 (wt%) | UL vertical flame test result | Ductile in bend test |
|---|---|---|---|---|---|
| E-3a | 48 | 36 | 16 | V-0 | Yes |
| E-3b | 46 | 36 | 18 | V-0 | Yes |

### Example 4

A test bar was molded with the following composition: Nylon-1 (67 wt%); Impact Modifier-1 (3 wt%); and MA Fibers (30 wt%). The MA Fibers were dried for 4 hours at 75° C. in a vacuum oven prior to compounding. The Impact Modifier-1 is added as an impact modifier but may serve both as an interfacial modifier and impact modifier. The test bar was allowed to age at room temperature under atmospheric conditions for 4 weeks. The test bar was bent in a metal clamp to a 90° angle, indicating that the composite is extremely ductile (>25% strain) and does not fail in a brittle manner.

### Example 5

Two test bars were molded with the following compositions: Nylon-1 (72 wt%); Interfacial-2 (1 wt%); and MA fibers (27 wt%). The interfacial modifier, behenyl alcohol, also acts as a lubricant. After aging for 2 weeks, the mean unnotched Izod impact strength was 23.7 ft-lbs/in 1,265 J/m).

### Example 6

This example demonstrates that hybrid composites have exceptional impact resistance. Two test bars were molded with the following composition: Nylon-2 (72 wt%); carbon fiber (14 wt%); and MA fiber (14 wt%). The test bars were allowed to equilibrate at room temperature and ~ 50% humidity for 3 months. One test bar was manually bent by flexing at a 90° angle resulting in permanent ductile deformation. This indicates that the material is capable of reaching strain levels > 20%, without failing in a brittle manner and exhibiting ductile behavior. When these molded test bars were aged for 12 months and tested according to ASTM D4812, the mean unnotched impact value was 36.2 ft-lbs/in (1,932 J/m).

### Example 7

A test bar was prepared with the following composition: Nylon-2 (45 wt%); FR-2 (15 wt%); and MA fiber (40 wt%). This test bar exhibited much higher flexural stiffness compared to example 1 and also exhibited ductile behavior without failure when flexed at a 60° angle. When tested in impact, the mean unnotched Izod value was 39.2 ft-lbs/in (2,092 J/m). This example shows that composites with higher fiber loadings display excellent impact resistance.

### Example 8

Four test bars (two of each composition) were prepared with the following two compositions. Composition 1 comprised: Nylon-1 (73 wt%); Interfacial-1 (2 wt%); and MA fiber (27 wt%). Composition 2 was the same as composition 1 with 27 wt% MA fiber, but did not contain the interfacial modifier. After being conditioned for 6 months at room temperature, the compositions were tested by manually flexing past a 90° angle. Both compositions were exceptionally ductile and could be flexed at high strains (>20%) without failure, resulting in permanent deformation. Composition 2 exhibited visually more stress whitening on the tensile side of the flexural bend compared to composition 1. After 12 months of aging, both compositions were tested according to ASTM D4812 and had unnotched Izod impact values >41.8 ft-lbs/in. (2,231 J/m) and all test bars did not break in the test. This example shows that compositions according to this disclosure have both exceptional ductility and impact resistance, far superior to any known discontinuous fiber thermoplastic composite including long glass fiber nylon composites. This example also shows that these materials have very high impact strength after aging in real world conditions. It is well known that nylon 6,6 has a fairly high equilibrium moisture content and impact properties improve with increasing moisture content.

### Example 9

One test bar was prepared with the following composition: Nylon-2 (37 wt%); FR-1(17 wt%), MA fiber (30 wt%), and Carbon fiber (16 wt%). The test bar was exceptionally stiff due the high fiber content.

What is claimed is:

1. A composite material comprising:
a matrix comprising at least one thermoplastic polyamide resin;
at least one impact modifier comprising at least 3 weight% based on the total weight of the composite material; and
7-60 wt% fiber reinforcing agent based upon the total weight of the composite
material, wherein the fiber reinforcing agent comprises discontinuous meta-aramid fibers; and wherein the composite material is melt processable, and is impact resistant as measured by an unnotched Izod test method according to ASTM D4812 having a value of at least 12 ft-lbs/in (640 J/m).

2. The composite material of claim 1, wherein the matrix comprises an aliphatic polyamide or a semi-aromatic polyamide.

3. The composite material of claim 1, wherein the fiber reinforcing agent comprises meta-aramid fibers with a length of 1-50 millimeters.

4. The composite material of claim 1, wherein the fiber reinforcing agent comprises meta-aramid fibers with a length of less than 1 millimeter.

5. The composite material of claim 1, wherein the fiber reinforcing agent comprises poly(m-phenylene isophthalamide) or copolymers of poly(m-phenylene isophthalamide).

6. The composite material of claim 1, wherein the fiber reinforcing agent further comprises at least one other class of fibers selected from carbon fibers, boron fibers, e-glass fibers, s-glass fibers, a-glass fibers, metal fibers, ceramic fibers, graphite fibers, and combinations thereof.

7. The composite material of claim 1, wherein the composite further comprises at least one additive, wherein the additive comprises a flame retardant or an interfacial modifier selected from maleated polyolefins, long chain alcohols, epoxy polymers or resins, zirconates, titanates, organosiloxane agents, and combinations thereof.

8. The composite of claim 7, wherein the composite comprises a flame retardant additive wherein the flame retardant additive contains phosphorus.

9. The composite material of claim 1, wherein the meta-aramid fiber reinforcing agent is present at a loading of 10-50 wt% based on the total weight of the composite composition.

10. The composite of claim 1, wherein the thermoplastic polyamide comprises nylon 6, nylon 6,6 or nylon 9T.

11. An article comprising:
a fiber-reinforced composite material, comprising:
a matrix comprising at least one thermoplastic polyamide resin;
at least one impact modifier comprising at least 3 weight% based on the total
weight of the composite material; and
7-60 wt% fiber reinforcing agent based upon the total weight of the composite
material, wherein the fiber reinforcing agent comprises discontinuous meta-aramid fibers; and wherein the composite material is melt processable, and is impact resistant as measured by an unnotched Izod test method according to ASTM D4812 having a value of at least 12 ft-lbs/in (640 J/m).

12. The article of claim 11, wherein the matrix comprises an aliphatic polyamide or a semi-aromatic polyamide.

13. The article of claim 11, wherein the fiber reinforcing agent comprises meta-aramid fibers with a length of 1-50 millimeters.

14. The article of claim 11, wherein the fiber reinforcing agent comprises meta-aramid fibers with a length of less than 1 millimeter.

15. The article of claim 11, wherein the fiber reinforcing agent further comprises carbon fibers.

16. The article of claim 11, wherein the composite further comprises at least one additive wherein the additive comprises a flame retardant, an interfacial modifier selected from maleated polyolefin copolymers, long chain alcohols, long chain fatty acids, epoxy polymers and oligomeric resins, semi-aromatic nylon copolymers, block copolymers, zirconates, titanates, organosiloxane agents, and combinations thereof.

17. The article of claim 11, wherein the fiber reinforcing agent is present at a loading of 10-50 wt% based on the total weight of the composite composition.

18. The article of claim 11, wherein the article comprises a personal safety article selected from a head protection article, a face protection article, eyewear protection, or a combination thereof or a combination thereof.

19. The article of claim 18, wherein the personal safety article comprises a helmet, a face shield or welding article, a mask, safety glasses, powered air respirators or components of powered air respirators, self-contained breathing apparatus, air filters, filter housings, protective earwear, protective boots or boot inserts.
